(19) United States
(12) Patent Application Publication
(10) Pub. No.: US 2023/0331144 A1
(43) Pub. Date: Oct. 19, 2023

(54) ROAD SURFACE DRAWING DEVICE FOR VEHICLE

(71) Applicant: TOYOTA JIDOSHA KABUSHIKI KAISHA, Aichi-ken (JP)

(72) Inventor: Fumihiko MOURI, Owariasahi-shi (JP)

(21) Appl. No.: 18/301,253

(22) Filed: Apr. 17, 2023

(30) Foreign Application Priority Data
Apr. 18, 2022 (JP) 2022-068131

(51) Int. Cl. B60Q 1/22

(52) U.S. Cl. CPC B60Q 1/22; B60Q 2400/50

(57) ABSTRACT

A road surface drawing device for a vehicle, which is installed in a vehicle and draws a notification display by light on a road surface in a traveling direction of the vehicle, switches drawing directions of the notification display and colors of the notification display in accordance with the traveling direction of the vehicle.

### CROSS REFERENCE TO RELATED APPLICATION

This application claims priority to Japanese Patent Application No. 2022-068131 filed on Apr. 18, 2022, which is incorporated herein by reference in its entirety including the specification, claims, drawings, and abstract.

### TECHNICAL FIELD

The present disclosure relates to a configuration of a road surface drawing device for a vehicle.

### BACKGROUND

A suggested road surface drawing device for a vehicle is installed in a vehicle and draws a drawn image of a predetermined shape on a road surface. For example, JP 2021-102409 A suggests a method in which in a road surface drawing device includes a light source, a lens, a lens driving unit, and a control unit, an angle of an optical axis of the lens is changed, and a position of a drawn image is thereby changed such that the position is moved away from a vehicle or moved close to the vehicle.

Further, configurations have been suggested in which rotation means is provided to a head lamp of a vehicle and an irradiation direction is rotationally moved (for example, see JP 2008-117561 A and JP 2006-224898 A).

Further, a circuit configuration has been suggested in which switching is possible between a white LED and a yellow LED in a fog lamp for an automobile (for example, see JP 2019-091653 A).

### SUMMARY

A road surface drawing device disclosed in JP 2021-102409 A changes a distance between a vehicle and a drawn image, but cannot change a drawing direction of the drawn image. Thus, in a case where display is drawn on a road surface in accordance with a traveling direction of the vehicle by using the road surface drawing device disclosed in JP 2021-102409 A, for example, many road surface drawing devices have to be installed in the vehicle in accordance with traveling directions of the vehicle such as a front direction, a left turn direction, a right turn direction, and a rear direction, thereby complicating a structure.

Accordingly, an advantage of the present disclosure is to provide a road surface drawing device for a vehicle which is capable of various notification displays corresponding to traveling directions of a vehicle by a simple method.

A road surface drawing device for a vehicle of the present disclosure is a road surface drawing device for a vehicle, the road surface drawing device being installed in a vehicle and drawing a notification display by light on a road surface in a traveling direction of the vehicle, in which drawing directions of the notification display and colors of the notification display are switched in accordance with the traveling direction of the vehicle.

Accordingly, various notification displays corresponding to traveling directions of the vehicle can be drawn.

The road surface drawing device for a vehicle of the present disclosure may include: a plurality of light sources that are arranged such that emission directions of light are set to different traveling directions of the vehicle; a shared lens that draws light, emitted from each of the light sources, as an image of the notification display on the road surface; a lens driving unit that rotates the lens; and a control unit that adjusts turning-ON and turning-OFF of each of the light sources and a rotation action of the lens driving unit, and each of the light sources may emit light in a different color, and the control unit may turn ON one light source whose emission direction of light corresponds to the traveling direction of the vehicle and may rotate the lens by the lens driving unit such that the emission direction of light of the one light source coincides with a direction of an optical axis of the lens.

Accordingly, with a simple configuration, the drawing directions and colors of the notification display can be switched in accordance with the traveling direction of the vehicle.

In the road surface drawing device for a vehicle of the present disclosure, each of the light sources may include a light emitting element, and a shade that transmits light emitted from the light emitting element as a bundle of light rays of the notification display, the lens may draw transmitted light, transmitted through each of the shades, as an image of the notification display on the road surface, and the shade of each of the light sources may transmit a different bundle of light rays, and the lens may draw an image of the notification display in a different shape on the road surface in accordance with the different bundle of light rays.

Accordingly, with a simple configuration, the drawing directions, colors, and shapes of the notification display can be switched in accordance with the traveling direction of the vehicle.

The road surface drawing device for a vehicle of the present disclosure may include: a plurality of light sources that are arranged such that emission directions of light are set to different traveling directions of the vehicle; a lens unit that is composed of a plurality of lens portions that each draw light, emitted from a respective one of the light sources, as an image of the notification display in a different position on the road surface; and a control unit that controls turning-ON and turning-OFF of each of the light sources, and each of the light sources may emit light in a different color, and the control unit may turn ON one light source whose emission direction of light corresponds to the traveling direction of the vehicle and may turn OFF the other light sources.

Accordingly, with a simple configuration which uses no motor, the drawing directions and colors of the notification display can be switched in accordance with the traveling direction of the vehicle. Further, because no motor is used, reduction in cost and failure rate can be achieved.

In the road surface drawing device for a vehicle of the present disclosure, each of the light sources may include a light emitting element, and a shade that transmits light emitted from the light emitting element as a bundle of light rays of the notification display, each of the lens portions may draw transmitted light, transmitted through the shade, as an image of the notification display on the road surface, the shade of each of the light sources may transmit a different bundle of light rays, and the lens portion may draw an image of the notification display in a different shape on the road surface in accordance with the different bundle of light rays.

Accordingly, with a simple configuration, the drawing directions, colors, and shapes of the notification display can be switched in accordance with the traveling direction of the vehicle.

In the road surface drawing device for a vehicle of the present disclosure, the lens unit may be an integrally formed component in which the plurality of lens portions are integrally formed.

Accordingly, the lens unit can have a compact configuration.

In the road surface drawing device for a vehicle of the present disclosure, in the lens unit, at least a part of a boundary surface of each of the lens portions may be formed as a total reflection surface of light.

Accordingly, light emitted from one light source can be restrained from being incident on the other lens portion which draws light from the other light source as an image on the road surface, and each notification display can be drawn clearly.

The road surface drawing device for a vehicle of the present disclosure may include: a casing; a light source array that is housed in the casing, is composed of a plurality of light emitting elements that emit light in different colors, and is capable of emitting light in a plurality of colors; a lens that is mounted on the casing and draws light from the light source array as an image of the notification display on the road surface; a casing driving unit that rotates the casing; and a control unit that adjusts turning-ON and turning-OFF of each of the light emitting elements of the light source array and a rotation action of the casing driving unit, and the control unit may rotate the casing, and changes colors of light to be emitted from the light source array in accordance with the traveling direction of the vehicle.

Accordingly, with a simple configuration, the drawing directions and colors of the notification display can be switched in accordance with the traveling direction of the vehicle.

The present disclosure can provide a road surface drawing device for a vehicle which is capable of various notification displays corresponding to traveling directions of a vehicle by a simple method.

### BRIEF DESCRIPTION OF DRAWINGS

Embodiments of the present disclosure will be described based on the following figures, wherein:

FIG. 1 is a schematic plan view illustrating a configuration of a road surface drawing device for a vehicle of an embodiment;

FIG. 2 is a schematic elevational view which illustrates the configuration of the road surface drawing device for a vehicle of the embodiment and which is an A-A view indicated in FIG. 1;

FIG. 3 is a function block diagram of the road surface drawing device for a vehicle of the embodiment;

FIG. 4 is a flowchart illustrating an action of the road surface drawing device for a vehicle of the embodiment;

FIG. 5 is a schematic plan view illustrating a configuration of a road surface drawing device for a vehicle of another embodiment;

FIG. 6 is a function block diagram of the road surface drawing device for a vehicle of the other embodiment;

FIG. 7 is a flowchart illustrating an action of the road surface drawing device for a vehicle of the other embodiment;

FIG. 8 is a schematic plan view illustrating a modification example of a lens unit of the road surface drawing device for a vehicle of the other embodiment;

FIG. 9 is a schematic plan view illustrating another modification example of the lens unit of the road surface drawing device for a vehicle of the other embodiment;

FIG. 10 is a schematic plan view illustrating a configuration of a road surface drawing device for a vehicle of another embodiment;

FIG. 11 is an elevational view which illustrates the configuration of the road surface drawing device for a vehicle of the other embodiment and which is a B-B arrow view indicated in FIG. 10;

FIG. 12 is a schematic plan view illustrating a configuration of a light source array of the road surface drawing device for a vehicle of the other embodiment;

FIG. 13 is a function block diagram of the road surface drawing device for a vehicle of the other embodiment; and

FIG. 14 is a flowchart illustrating an action of the road surface drawing device for a vehicle of the other embodiment.

### DESCRIPTION OF EMBODIMENTS

A road surface drawing device 20 for a vehicle of an embodiment will hereinafter be described with reference to drawings. An arrow FR, an arrow UP, and an arrow RH indicated in the drawings respectively denote a front direction (traveling direction), an upper direction, and a right direction of a vehicle 10. Further, the opposite directions of the arrows FR, UP, and RH indicate a vehicle rear direction, a lower direction, and a left direction, respectively. Hereinafter, in cases where descriptions are made by using directions of simply front and rear, left and right, and up and down, unless otherwise specified, these denote front and rear in a vehicle front-rear direction, left and right in a vehicle left-right direction (vehicle width direction), and up and down in a vehicle up-down direction. Note that in the following description, the road surface drawing device 20 for a vehicle that is described is mounted on a corner portion on a left side of a rear portion of the vehicle 10. Because the road surface drawing device 20 for a vehicle which is mounted on a corner portion on a right side of the rear portion of the vehicle 10 is in left-right symmetry with the road surface drawing device 20 for a vehicle on the left side, views by drawings and descriptions will not be provided.

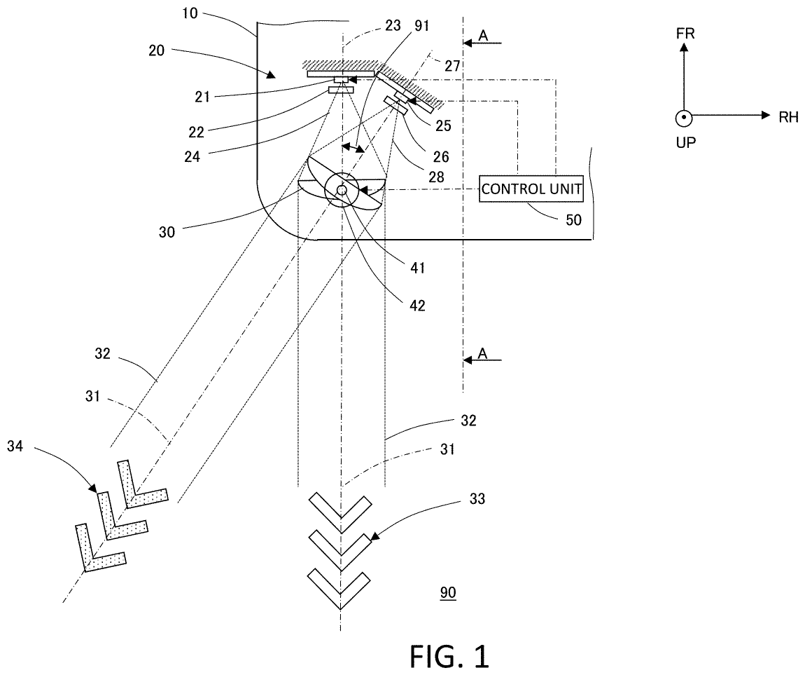

As illustrated in FIG. 1, the road surface drawing device 20 for a vehicle of the embodiment includes a first LED 21, a second LED 25, a first shade 22, a second shade 26, a lens 30, a lens driving motor 42, and a control unit 50.

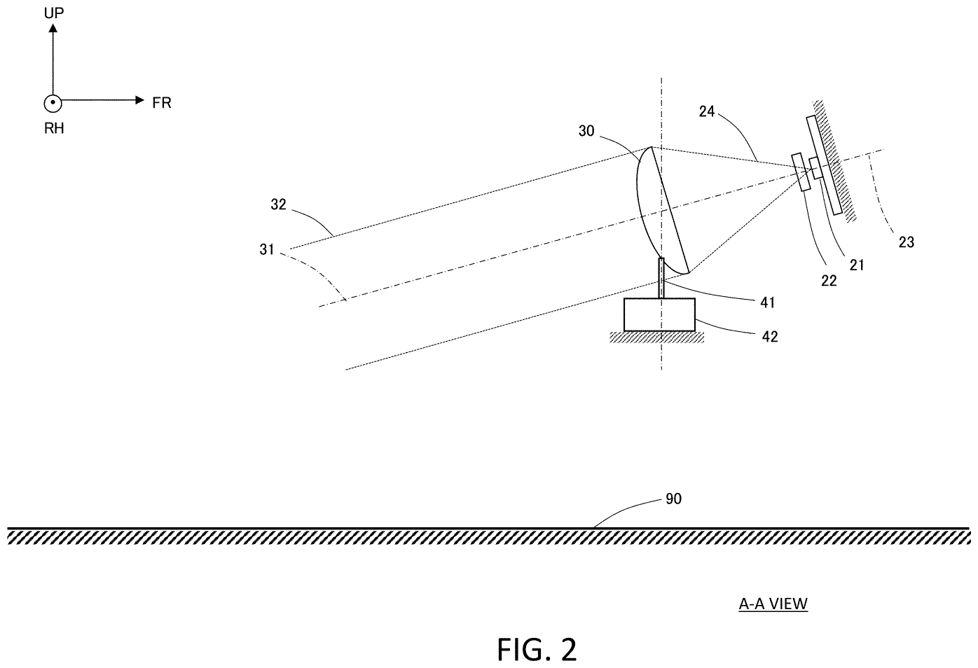

As illustrated in FIG. 1 and FIG. 2, the first LED 21 is a light emitting element which emits while light and is fixed to the corner portion on the left side of the rear portion of the vehicle 10 such that an emission direction 23 of light is directed rearward and obliquely downward from the vehicle 10. The second LED 25 is a light emitting element which emits orange light, which is different from white, and is fixed to the corner portion on the left side of the rear portion of the vehicle 10 such that an emission direction 27 of light is directed obliquely leftward rearward and obliquely downward from the vehicle 10. In such a manner, the first and second LEDs 21 and 25 are arranged such that the respective emission directions 23 and 27 of light are different from each other and are set to rear and obliquely left rear as traveling directions of the vehicle 10.

The first shade 22 and the second shade 26 are respectively arranged in optical paths 24 and 28 of the light emitted from the first and second LEDs 21 and 25, transmit the light emitted from the first and second LEDs 21 and 25 as bundles of light rays of notification displays 33 and 34, and block other light. For example, as the notification displays 33 and 34 illustrated in FIG. 1, in a case where images are composed of three chevron signs, holes in shapes corresponding to the chevron signs are provided in the first and second shades 22 and 26, and the light emitted from the first LED 21 and the light emitted from the second LED 25 are transmitted as bundles of light rays of the three chevron signs. Here, the first LED 21 and the first shade 22 configure a first light source, and the second LED 25 and the second shade 26 configure a second light source.

The lens 30 is arranged in the optical paths 24 and 28 of the light emitted from the first and second LEDs 21 and 25, guides respective beams of transmitted light which are transmitted through the first and second shades 22 and 26 in a direction of an optical path 32, and draws those as images of the notification displays 33 and 34 on a road surface 90. The lens 30 is shared by the first LED 21 and the second LED 25 and is rotated as indicated by arrows 91 in FIG. 1 in a planar view around a rotation shaft 41, as a center, which is perpendicularly arranged in a position of an intersection point between the emission direction 23 of light of the first LED 21 and the emission direction 27 of light of the second LED 25. The lens driving motor 42 that rotates and drives the lens 30 is connected with the rotation shaft 41 of the lens 30. The lens driving motor 42 configures a lens driving unit. In a case where an optical axis 31 of the lens 30 coincides with the emission direction 23 of light of the first LED 21 by the lens driving motor 42, the lens 30 draws a white notification display 33 on a rear road surface 90 by the white light emitted from the first LED 21. Further, in a case where an optical axis 31 coincides with the emission direction 27 of light of the second LED 25, the lens 30 draws an orange notification display 34 on an obliquely left rear road surface 90 by the orange light emitted from the second LED 25.

The first LED 21, the second LED 25, and the lens driving motor 42 are connected with the control unit 50 and act by a command from the control unit 50.

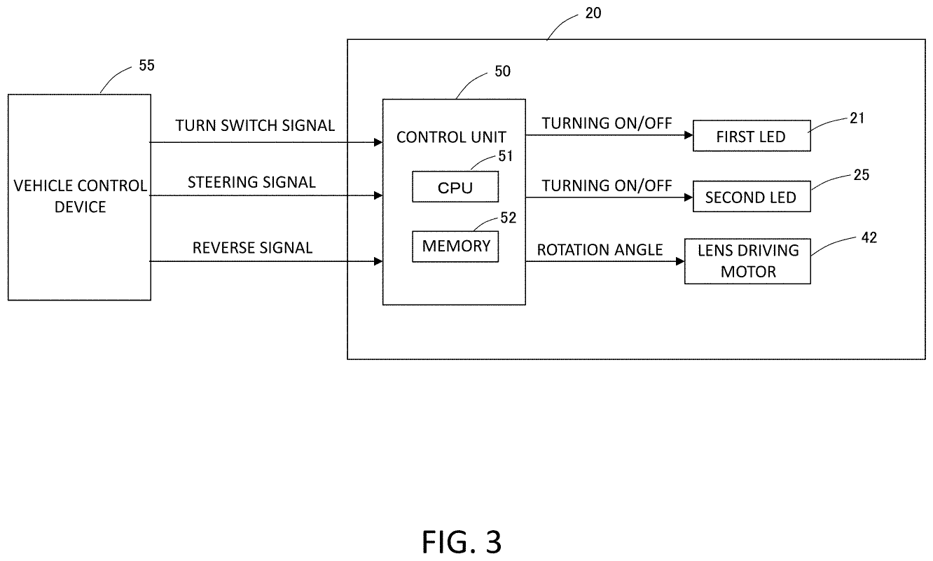

As illustrated in FIG. 3, the control unit 50 is a computer which, in its internal portion, includes a CPU 51 as a processor performing information processing and a memory 52 storing action programs and data. To the control unit 50, a turn switch signal, a steering signal, and a reverse signal are input from a vehicle control device 55 which is installed in the vehicle 10. Here, the turn switch signal is a signal which indicates that a turn switch mounted on the vehicle 10 is turned ON to a left turn side or a right turn side. Further, the steering signal is a signal which indicates that a steering wheel operation is performed and the traveling direction of the vehicle 10 becomes a left turn direction or a right turn direction. The reverse signal is a signal which indicates that a shift lever of the vehicle 10 is in a reverse position. The CPU 51 of the control unit 50 adjusts turning-ON or turning-OFF of the first LED 21 and the second LED 25 and a rotation angle of the lens driving motor 42 in accordance with those signals.

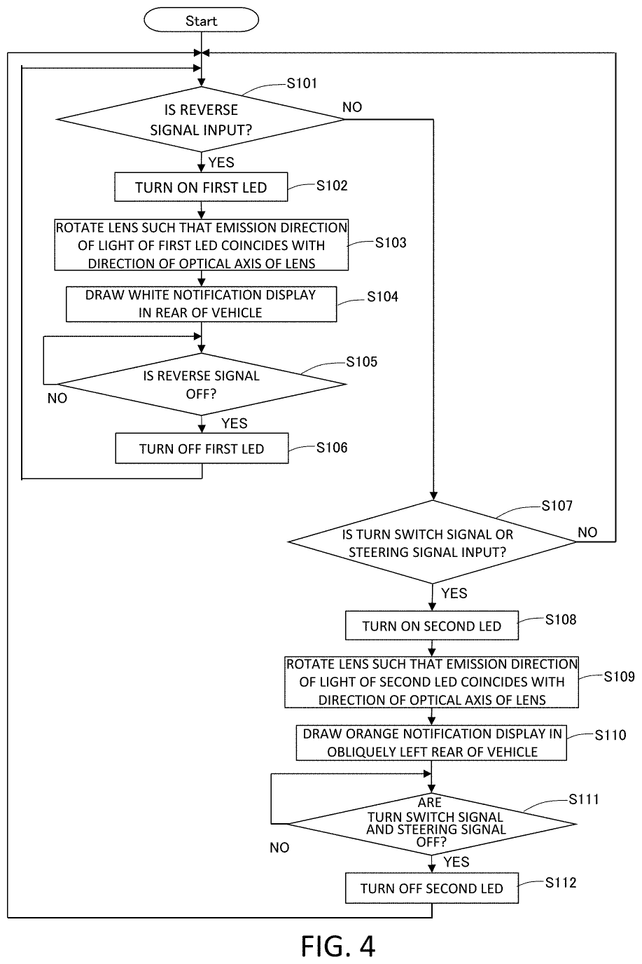

Next, an action of the road surface drawing device 20 for a vehicle configured as described above will be described with reference to FIG. 4. The CPU 51 of the control unit 50 starts the road surface drawing device 20 for a vehicle when a start switch of the vehicle 10 is turned ON.

As indicated by steps S101 and S107 in FIG. 4, the CPU 51 waits until the reverse signal is input or the turn switch signal or the steering signal is input from the vehicle control device 55 while repeatedly executing steps S101 and S107 in FIG. 4.

Then, when the reverse signal is input from the vehicle control device 55, the CPU 51 makes a determination of YES in step S101 in FIG. 4, moves to step S102 in FIG. 4, and turns ON the first LED 21. Then, the CPU 51 rotates the lens 30 by the lens driving motor 42 such that the emission direction 23 of light of the first LED 21 coincides with a direction of the optical axis 31 of the lens 30 in step S103 in FIG. 4 and draws the white notification display 33 on the road surface 90 in the rear of the vehicle 10 as illustrated in FIG. 1 in step S104 in FIG. 4.

The CPU 51 waits until the reverse signal from the vehicle control device 55 is turned OFF in step S105 in FIG. 4. Then, when the reverse signal is turned OFF, the CPU 51 makes a determination of YES in step S105 in FIG. 4, moves to step S106 in FIG. 4, turns OFF the first LED 21, returns to step S101 in FIG. 4, and waits until the reverse signal is input or the turn switch signal or the steering signal is input from the vehicle control device 55.

When the turn switch signal or the steering signal for a left turn is input from the vehicle control device 55, the CPU 51 makes a determination of YES in step S107 in FIG. 4, moves to step S108 in FIG. 4, and turns ON the second LED 25. Then, in step S109 in FIG. 4 the CPU 51 rotates the lens 30 by the lens driving motor 42 such that the emission direction 27 of light of the second LED 25 coincides with the direction of the optical axis 31 of the lens 30, and in step S110 in FIG. 4, draws the orange notification display 34 on the road surface 90 in obliquely left rear of the vehicle 10 as illustrated in FIG. 1.

In step S111 in FIG. 4 the CPU 51 waits until the turn switch signal or the steering signal from the vehicle control device 55 is turned OFF. Then, when the turn switch signal or the steering signal is turned OFF, the CPU 51 makes a determination of YES in step S111 in FIG. 4, moves to step S112 in FIG. 4, turns OFF the second LED 25, returns to step S101 in FIG. 4, and waits until the reverse signal is input or the turn switch signal or the steering signal is input from the vehicle control device 55.

The CPU 51 repeatedly executes actions of steps S101 to S112 indicated in FIG. 4 until the start switch of the vehicle 10 is turned OFF, and finishes the actions when the start switch is turned OFF.

As described above, the road surface drawing device 20 for a vehicle of the embodiment can switch drawing directions of the notification displays 33 and 34 between the rear and the obliquely left rear of the vehicle 10 and can switch colors of the notification displays 33 and 34 between white and orange in accordance with whether the traveling direction of the vehicle 10 is a reverse direction or the left turn direction. In such a manner, with a simple configuration, the road surface drawing device 20 for a vehicle of the embodiment can switch the drawing directions and colors of the notification displays 33 and 34 in accordance with the traveling direction of the vehicle 10.

Further, in the above description, a description is made on the assumption that each of the first and second shades 22 and 26 is provided with the holes in the same shape which correspond to the three chevron signs, but this is not restrictive. For example, the shape of the hole of the second shade 26 may be made a different shape from the shape of the hole of the first shade 22, and a shape of the notification display 34 may thereby be made different from a shape of the notification display 33.

Accordingly, with a simple configuration, the shape of the notification display 34 can be switched in addition to the drawing directions and colors of the notification displays 33 and 34 in accordance with the traveling direction of the vehicle 10, and various notification displays 33 and 34 corresponding to the traveling direction of the vehicle 10 can be drawn.

Further, in the above description, a description is made on the assumption that in the road surface drawing device 20 for a vehicle, the first and second LEDs 21 and 25 are arranged such that the respective emission directions 23 and 27 of light are set to the rear and the obliquely left rear as different traveling directions of the vehicle 10, but this is not restrictive. For example, the road surface drawing device 20 for a vehicle is caused to further include a third LED whose emission direction of light is a left direction of the vehicle 10 and whose color of light is different from those of the first and second LEDs 21 and 25, for example, green, and a green notification display may be drawn on the road surface 90 on a left side of the vehicle 10 in a case where the vehicle 10 makes a left turn. In addition, the road surface drawing device 20 for a vehicle may include four or more LEDs such that emission directions of light correspond to different traveling directions of the vehicle 10.

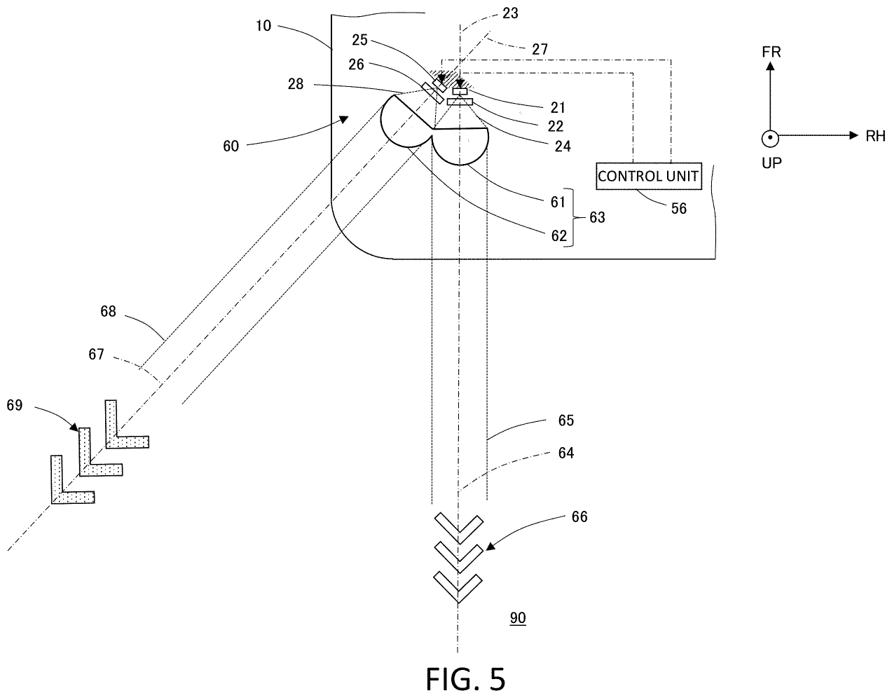

Next, a road surface drawing device 60 for a vehicle of another embodiment will be described with reference to FIGS. 5 to 7. The same reference numerals are assigned to the same portions as those of the road surface drawing device 20 for a vehicle which were described earlier with reference to FIGS. 1 to 4, and descriptions thereof will not be repeated.

As illustrated in FIG. 5, in the road surface drawing device 60 for a vehicle, the lens of the road surface drawing device 20 for a vehicle is changed to a lens unit 63 which is composed of a first lens portion 61 and a second lens portion 62, and the control unit 50 is changed to a control unit 56.

As illustrated in FIG. 5, the first lens portion 61 is arranged such that an optical axis 64 coincides with the emission direction 23 of light of the first LED 21, guides light emitted from the first LED 21 to the rear of the vehicle 10 along an optical path 65, and draws an image of a notification display 66 on the road surface 90 in the rear of the vehicle 10. Similarly, the second lens portion 62 is arranged such that an optical axis 67 coincides with the emission direction 27 of light of the second LED 25, guides light emitted from the second LED 25 to the obliquely left rear of the vehicle 10 along an optical path 68, and draws an image of a notification display 69 on the road surface 90 in the obliquely left rear of the vehicle 10.

The first lens portion 61 and the second lens portion 62 are an integrally formed component, and at least parts of the first lens portion 61 and the second lens portion 62 are connected together.

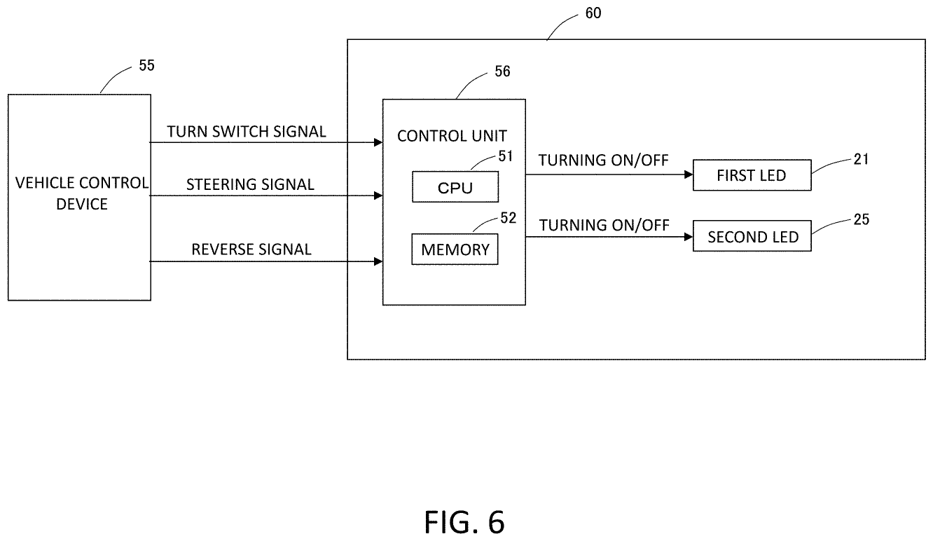

Further, as illustrated in FIG. 6, the control unit 56 is connected with the first and second LEDs 21 and 25 and controls turning-ON and turning-OFF of the first and second LEDs 21 and 25.

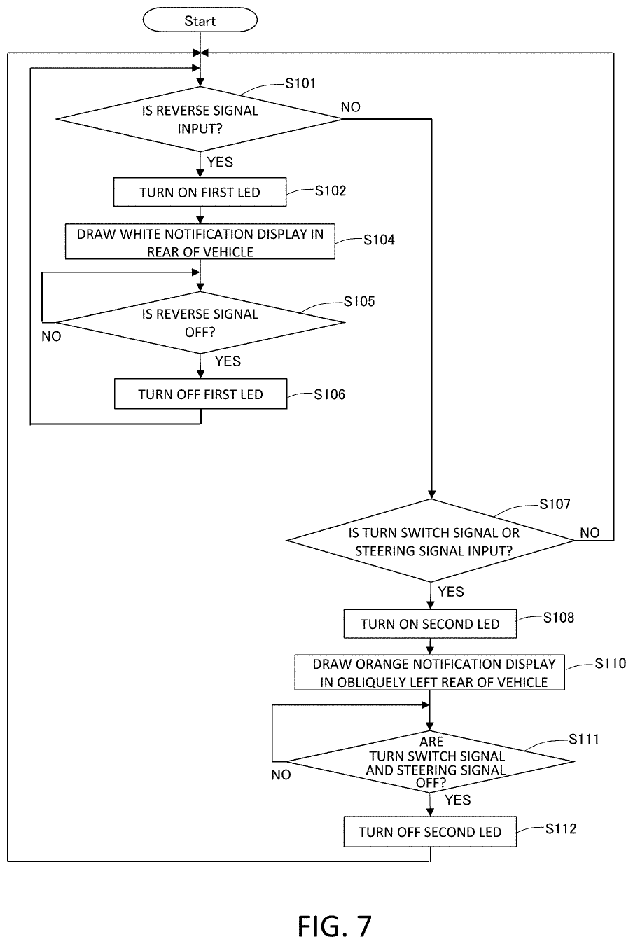

Next, an action of the road surface drawing device 60 for a vehicle will be described with reference to FIG. 7. The same step numerals are given to actions similar to those of the road surface drawing device 20 for a vehicle which were described earlier with reference to FIG. 4, and descriptions thereof will not be repeated.

As illustrated in FIG. 7, the action of the road surface drawing device 60 for a vehicle does not include a rotation action of the lens 30 which is indicated by steps S103 and S109 indicated in FIG. 4, and the first and second LEDs 21 and 25 are turned ON and turned OFF in accordance with an input of the reverse signal, the turn switch signal, or the steering signal.

As in the road surface drawing device 20 for a vehicle, the CPU 51 of the road surface drawing device 60 for a vehicle can switch drawing directions of the notification displays 66 and 69 between the rear and the obliquely left rear of the vehicle 10 and can switch colors of the notification displays 66 and 69 between white and orange in accordance with whether the traveling direction of the vehicle 10 is the reverse direction or the left turn direction. In such a manner, with a simple configuration, the road surface drawing device 60 for a vehicle of the embodiment can switch the drawing directions and colors of the notification displays 66 and 69 in accordance with the traveling direction of the vehicle 10.

Further, as in the road surface drawing device 20 for a vehicle, in the road surface drawing device 60 for a vehicle, the shapes of the holes of the first shade 22 and the second shade 26 are made different, and shapes of the notification displays 66 and 69 may be switched in accordance with the traveling direction of the vehicle 10.

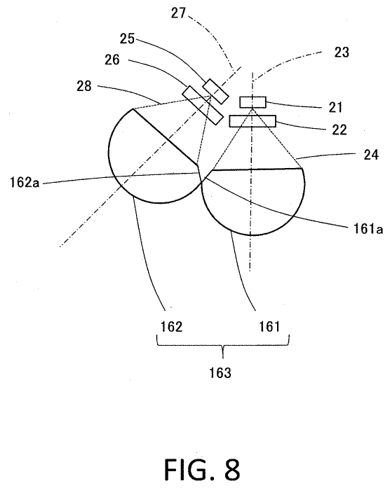

Further, as illustrated in FIG. 8, a part of a boundary surface between a first lens portion 161 and a second lens portion 162 is formed as a total reflection surface 161a of light, a part of a boundary surface between the second lens portion 162 and the first lens portion 161 is formed as a total reflection surface 162a of light, and thereby light may be inhibited from being transmitted between the first lens portion 161 and the second lens portion 162. Consequently, the notification displays 66 and 69 can be drawn more clearly on the road surface 90.

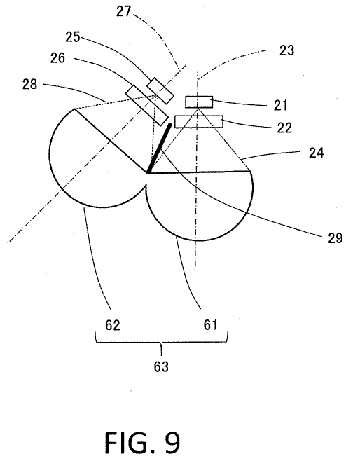

Further, as illustrated in FIG. 9, a shielding plate 29 through which no light passes is provided between the optical path 24 of the first LED 21 and the optical path 28 of the second LED 25, and respective beams of light emitted from the first and second LEDs 21 and 25 may be prevented from being incident on the second lens portion 62 and the first lens portion 61, respectively. Accordingly, the notification displays 66 and 69 can be drawn more clearly on the road surface 90.

Further, as in the road surface drawing device 20 for a vehicle which was described earlier, the road surface drawing device 60 for a vehicle may include a third LED whose color of light is a color different from those of the first and second LEDs 21 and 25 and whose emission direction of light becomes the left direction of the vehicle 10 and a third lens portion which guides light emitted from the third LED to the left of the vehicle 10 and draws a notification display on the road surface 90 on a left side of the vehicle 10. In addition, the road surface drawing device 60 for a vehicle may include four or more LEDs and four or more lens portions such that emission directions of light correspond to different traveling directions of the vehicle 10.

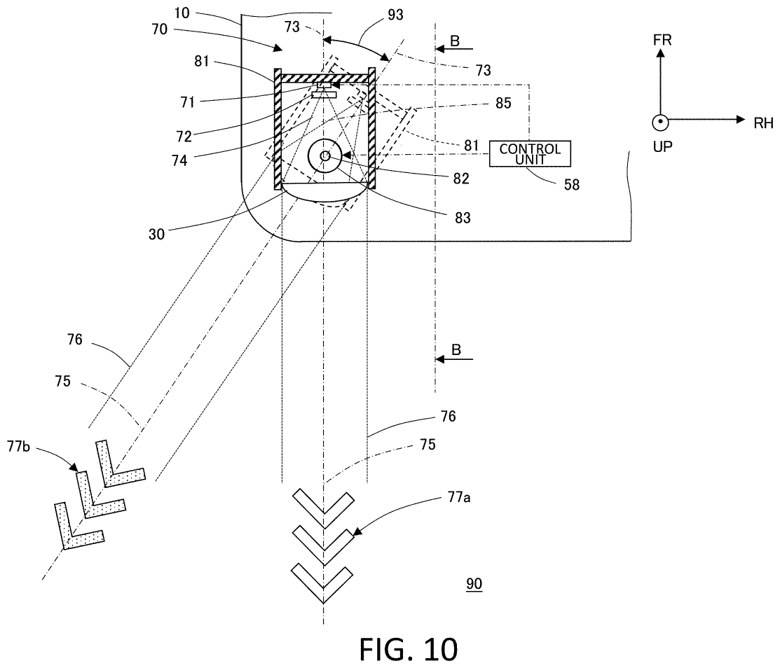

Next, a road surface drawing device 70 for a vehicle of another embodiment will be described with reference to FIGS. 10 to 14. The same reference numerals are assigned to the same portions as those of the road surface drawing device 20 for a vehicle which were described earlier with reference to FIGS. 1 to 4, and descriptions thereof will not be repeated.

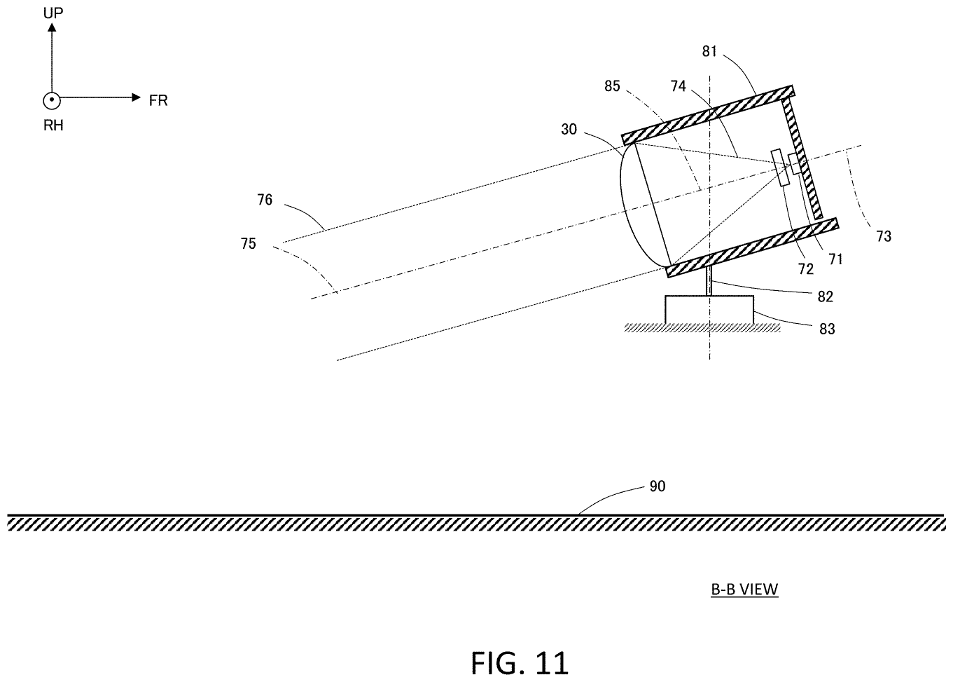

As illustrated in FIGS. 10 and 11, the road surface drawing device 70 for a vehicle includes a casing 81, a light source array 71 which is housed in the casing 81, a shade 72, the lens 30 mounted on the casing 81, a casing driving motor 83 that rotates and drives the casing 81, and a control unit 58. The casing 81 indicated by solid lines in FIG. 10 indicates a state where an axis direction 85 of the casing 81 is set to the rear of the vehicle 10, and the casing 81 indicated by broken lines indicates a state where the casing 81 is rotated such that the axis direction 85 of the casing 81 is set to the obliquely left rear of the vehicle 10.

As illustrated in FIG. 11, the casing 81 is mounted on the vehicle 10 while being inclined such that an emission direction 73 of light from the light source array 71 is directed obliquely downward for the vehicle 10. The casing 81 is rotated around a rotation shaft 82, as a center, which is perpendicularly arranged as indicated by arrows 93 in FIG. in a planar view. The casing driving motor 83 that rotates and drives the casing 81 is connected with the rotation shaft 82 of the casing 81. The casing driving motor 83 configures a casing driving unit.

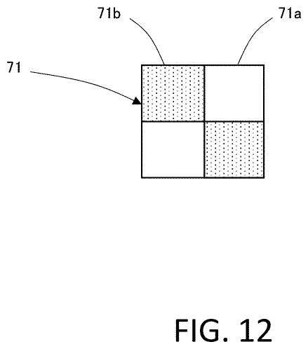

As illustrated in FIG. 12, the light source array 71 is an array in which a plurality of white LEDs 71a and a plurality of orange LEDs 71b are arranged in an array manner, can emit white light by turning ON only the white LEDs 71a, and can emit orange light by turning ON only the orange LEDs 71b.

Returning to FIG. 10, the shade 72 is provided in an optical path 74 of light emitted from the light source array 71. The shade 72 has the same structure as the first and second shades 22 and 26 which were described earlier with reference to FIGS. 1 to 4.

The lens 30 draws on the road surface 90 light from the light source array 71 as images of notification displays 77a and 77b. The lens 30 is mounted on the casing 81 such that a direction of an optical axis 75 coincides with the axis direction 85 of the casing 81.

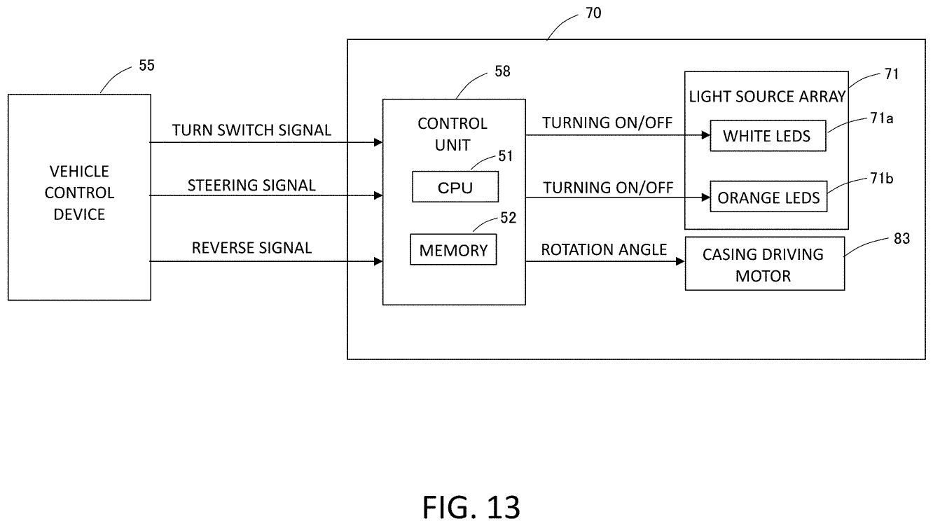

As illustrated in FIG. 13, based on the turn switch signal, the steering signal, and the reverse signal which are input from the vehicle control device 55, the control unit 58 adjusts turning-ON and turning-OFF of the white LEDs 71a and orange LEDs 71b of the light source array 71 and a rotation angle of the casing driving motor 83.

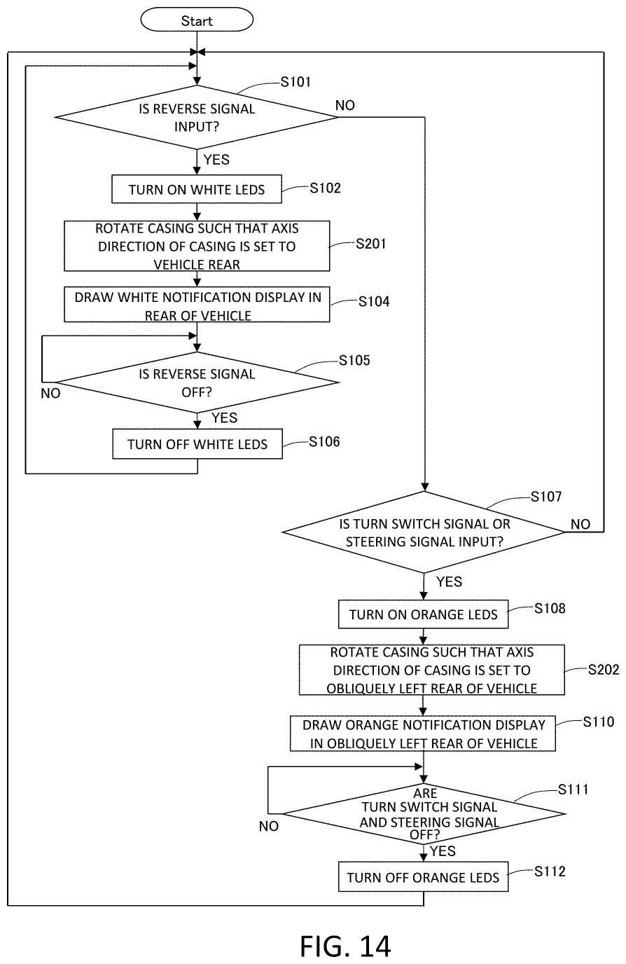

Next, an action of the road surface drawing device 70 for a vehicle will be described with reference to FIG. 14. The same step numerals are assigned to the same actions as the actions of the road surface drawing device 20 for a vehicle which were described earlier with reference to FIG. 4, and descriptions thereof will not be repeated.

As indicated by steps S101 and S102 in FIG. 14, the CPU 51 of the road surface drawing device 70 for a vehicle turns ON the white LEDs 71a when the reverse signal is input from the vehicle control device 55, and in step S201 in FIG. 14 rotates the casing 81 by the casing driving motor 83 such that the axis direction 85 of the casing 81 is set to the rear of the vehicle 10. Then, the CPU 51 draws the white notification display 77a on the road surface 90 in the rear of the vehicle 10 in step S104 in FIG. 14.

Further, as indicated by steps S107 and S108 in FIG. 14, the CPU 51 turns ON the orange LEDs 71b when the turn switch signal or the steering signal is input from the vehicle control device 55, and in step S202 in FIG. 14 rotates the casing 81 by the casing driving motor 83 such that the axis direction 85 of the casing 81 is set to the obliquely left rear of the vehicle 10. Then, the CPU 51 draws the orange notification display 77b on the road surface 90 in the obliquely left rear of the vehicle 10 in step S110 in FIG. 14.

With a simple configuration, the road surface drawing device 70 for a vehicle can switch the drawing directions and colors of the notification displays 77a and 77b in accordance with the traveling direction of the vehicle 10.

In the above description, a description is made on the assumption that the light source array 71 is composed of light emitting elements of two colors which are the white LEDs 71a and the orange LEDs 71b, but this is not restrictive. The light source array 71 may be configured to include green LEDs which emit green light, for example, other than white and orange, and a green notification display may thereby be performed on the road surface 90 when the axis direction 85 of the casing 81 is set to the left direction of the vehicle 10. Further, the light source array 71 may be composed of four or more LEDs with different light emission colors.

1. A road surface drawing device for a vehicle, the road surface drawing device being installed in a vehicle and drawing a notification display by light on a road surface in a traveling direction of the vehicle, wherein
drawing directions of the notification display and colors of the notification display are switched in accordance with the traveling direction of the vehicle.

2. The road surface drawing device for a vehicle according to claim 1, the road surface drawing device comprising:
a plurality of light sources that are arranged such that emission directions of light are set to different traveling directions of the vehicle;
a shared lens that draws light, emitted from each of the light sources, as an image of the notification display on the road surface;
a lens driving unit that rotates the lens; and
a control unit that adjusts turning-ON and turning-OFF of each of the light sources and a rotation action of the lens driving unit, wherein
each of the light sources emits light in a different color, and
the control unit turns ON one light source whose emission direction of light corresponds to the traveling direction of the vehicle and rotates the lens by the lens driving unit such that the emission direction of light of the one light source coincides with a direction of an optical axis of the lens.

3. The road surface drawing device for a vehicle according to claim 2, wherein
each of the light sources includes a light emitting element and a shade that transmits light emitted from the light emitting element as a bundle of light rays of the notification display,
the lens draws transmitted light, transmitted through each of the shades, as an image of the notification display on the road surface, and
the shade of each of the light sources transmits a different bundle of light rays, and
the lens draws an image of the notification display in a different shape on the road surface in accordance with the different bundle of light rays.

4. The road surface drawing device for a vehicle according to claim 1, the road surface drawing device comprising:
a plurality of light sources that are arranged such that emission directions of light are set to different traveling directions of the vehicle;
a lens unit that is composed of a plurality of lens portions that each draw light, emitted from a respective one of the light sources, as an image of the notification display in a different position on the road surface; and
a control unit that controls turning-ON and turning-OFF of each of the light sources, wherein
each of the light sources emits light in a different color, and
the control unit turns ON one light source whose emission direction of light corresponds to the traveling direction of the vehicle and turns OFF the other light sources.

5. The road surface drawing device for a vehicle according to claim 4, wherein
each of the light sources includes a light emitting element and a shade that transmits light emitted from the light emitting element as a bundle of light rays of the notification display,
each of the lens portions draws transmitted light, transmitted through the shade, as an image of the notification display on the road surface,
the shade of each of the light sources transmits a different bundle of light rays, and
the lens portion draws an image of the notification display in a different shape on the road surface in accordance with the different bundle of light rays.

6. The road surface drawing device for a vehicle according to claim 4, wherein
the lens unit is an integrally formed component in which the plurality of lens portions are integrally formed.

7. The road surface drawing device for a vehicle according to claim 5, wherein
the lens unit is an integrally formed component in which the plurality of lens portions are integrally formed.

8. The road surface drawing device for a vehicle according to claim 6, wherein
in the lens unit, at least a part of a boundary surface of each of the lens portions is formed as a total reflection surface of light.

9. The road surface drawing device for a vehicle according to claim 7, wherein
in the lens unit, at least a part of a boundary surface of each of the lens portions is formed as a total reflection surface of light.

10. The road surface drawing device for a vehicle according to claim 1, the road surface drawing device comprising:
a casing;
a light source array that is housed in the casing, is composed of a plurality of light emitting elements that emit light in different colors, and is capable of emitting light in a plurality of colors;
a lens that is mounted on the casing and draws light from the light source array as an image of the notification display on the road surface;
a casing driving unit that rotates the casing; and
a control unit that adjusts turning-ON and turning-OFF of each of the light emitting elements of the light source array and a rotation action of the casing driving unit, wherein
the control unit rotates the casing and changes colors of light to be emitted from the light source array in accordance with the traveling direction of the vehicle.
